(19) United States
(12) Patent Application Publication
(10) Pub. No.: US 2013/0182686 A1
(43) Pub. Date: Jul. 18, 2013

(54) OPTIMIZATION OF DUAL BSS SCHEDULING

(71) Applicants: Ramanuja VEDANTHAM, Allen, TX (US); Michael GLIK, Kfar-Saba (IL); Ariton E. XHAFA, Plano, TX (US); Yanjun SUN, Richardson, TX (US)

(72) Inventors: Ramanuja VEDANTHAM, Allen, TX (US); Michael GLIK, Kfar-Saba (IL); Ariton E. XHAFA, Plano, TX (US); Yanjun SUN, Richardson, TX (US)

(73) Assignee: TEXAS INSTRUMENTS INCORPORATED, Dallas, TX (US)

(21) Appl. No.: 13/552,408

(22) Filed: Jul. 18, 2012

Related U.S. Application Data
(60) Provisional application No. 61/509,265, filed on Jul. 19, 2011.

(51) Int. Cl. H04W 72/04

(52) U.S. Cl. CPC H04W 72/0486
USPC 370/336

(57) ABSTRACT

An integrated circuit includes logic configured to determine a communication schedule of a device configured to perform Wi-Fi communications in a first Basic Service Set (BSS) network and in a second BSS network. The logic determines the communication schedule based at least in part on a first BSS network communication load of the device and on a second BSS network communication load of the device. The communication schedule defines the service time allocation of the device in the first BSS network and the service time allocation of the device in the second BSS network. At least one of the first and the second BSS networks is supportive of a peer-to-peer connection.

### CROSS-REFERENCE TO RELATED APPLICATION

The present application claims priority to U.S. Provisional Patent Application No. 61/509,265 filed on Jul. 19, 2011 (Attorney Docket No. TI-71216PS), which is hereby incorporated herein by reference in its entirety; and is related to U.S. patent application Ser. No. 13/166,428 (Attorney Docket No. TI-69894), which is hereby incorporated herein by reference in its entirety.

### BACKGROUND

There are more than 1 billion Wi-Fi devices in use today. Wi-Fi is widely available in homes, Wi-Fi hotspots, enterprise environments, and is found in many types of devices. The Wi-Fi Alliance has more than 350 member companies, and has completed numerous product certifications. As such, any efficiencies in Wi-Fi communication will have a wide impact.

### SUMMARY

Embodiments for efficient dual basic service set scheduling are described herein. In an embodiment, an integrated circuit that includes logic configured to determine a communication schedule of a device configured to perform Wi-Fi communications in a first Basic Service Set (BSS) network and in a second BSS network is disclosed. The logic determines the communication schedule based at least in part on a first BSS network communication load of the device and on a second BSS network communication load of the device. The communication schedule defines the service time allocation of the device in the first BSS network and the service time allocation of the device in the second BSS network. At least one of the first and the second BSS networks is supportive of a peer-to-peer connection.

In an embodiment, a method is disclosed. The method comprises determining by a processor a first Wi-Fi communication load of a device in a first Basic Service Set (BSS) network and a second Wi-Fi communication load of the device in a second BSS network. The method further comprises, based on the first Wi-Fi communication load, determining by the processor a first service time allocation schedule of the device for the first BSS network, and based on the second Wi-Fi communication load, determining by the processor a second service time allocation schedule of the device for the second BSS network.

In an embodiment, an integrated circuit is disclosed. The integrated circuit comprises logic configured to determine a communication schedule of a device configured to perform Wi-Fi communications in a first Basic Service Set (BSS) network and in a second BSS network, wherein the logic determines the communication schedule based at least in part on a first BSS network communication load of the device and on a second BSS network communication load of the device, and wherein the communication schedule defines the service time allocation of the device in the first BSS network and the service time allocation of the device in the second BSS network. The first BSS network is a legacy Wi-Fi network and the second BSS network supports a peer-to-peer connection. Determining the first BSS network communication load comprises identifying a downlink traffic pending by reading a transmit indication map (TIM) and determining uplink traffic pending on the device.

These and other features and advantages will be more clearly understood from the following detailed description taken in conjunction with the accompanying drawings and claims.

### BRIEF DESCRIPTION OF THE DRAWINGS

For a more complete understanding of the present disclosure, reference is now made to the accompanying drawings and detailed description, wherein like reference numerals represent like parts:

FIG. 1 illustrates an example of specific devices in a dual BSS configuration in accordance with at least some illustrative embodiments;

FIG. 2 illustrates another example of a dual BSS configuration in accordance with at least some illustrative embodiments;

FIG. 3 illustrates a dual BSS device in accordance with at least some illustrative embodiments;

FIG. 4 illustrates BSS service time allocation in accordance with at least some illustrative embodiments;

FIG. 5 illustrates a method for dual BSS scheduling in accordance with at least some illustrative embodiments; and

FIG. 6 illustrates a particular machine suitable for implementing one or more embodiments described herein.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or a direct electrical connection. Thus, if a first device couples to a second device, that connection may be through a direct electrical connection, or through an indirect electrical connection via other devices and connections.

The terms “computer readable medium” or “machine readable medium” as referred to herein relates to non-transitory media capable of maintaining expressions that are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium, and embodiments are not limited in this respect.

The term “logic” as referred to herein relates to structure for performing one or more logical operations. For example, logic may comprise circuitry that provides one or more output signals based upon one or more input signals. Such circuitry may comprise a finite state machine, which receives a digital input and provides a digital output, or circuitry, which provides one or more analog output signals in response to one or more analog input signals. Such circuitry may be provided in an application specific integrated circuit (“ASIC”) or field programmable gate array (“FPGA”). In some contexts, the logic may also be referred to as a processor. Also, logic may comprise machine-readable instructions stored in a memory in combination with processing circuitry to execute such machine-readable instructions. However, these are merely examples of structures that may provide logic, and embodiments are not limited in this respect.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Wi-Fi Direct devices connect in a way that makes it convenient for users to print, share, and display files. Wi-Fi Direct devices connect directly to one another without access to traditional network infrastructure such as stations (“STAs”) or access points (“APs”). As such, mobile phones, cameras, printers, computers, gaming devices, and the like can connect to each other directly to transfer content and share applications without network infrastructure. Devices can make a one-to-one connection, or a group of several devices can connect simultaneously. The devices can connect for a single exchange, or the devices can retain the memory of the connection and link together each time the devices are in proximity.

Wi-Fi Direct is also known as Wi-Fi Peer-to-Peer (“P2P”), and the Wi-Fi Peer to Peer Technical Specification, Version 1.0.14, Wi-Fi Alliance Technical Committee, P2P Task Group, 2010 is incorporated by reference as if fully reproduced herein. A Wi-Fi Direct device is capable of peer-to-peer connections as well as infrastructure connections. Wi-Fi Direct devices connect by forming Groups in a one-to-one or one-to-many topology. A single Wi-Fi Direct device is in charge of the Group including controlling which devices are allowed to join the Group and when the Group is terminated. This Group Master will appear as an access point (“AP”) to legacy devices. The Group Master is not an AP, but it provides some of the services commonly provided by an AP. In some contexts herein, the Group Master may be referred to as the group owner. Examples include BSS functionality, Wi-Fi Protected Setup Internal Registrar functionality, and communication management between clients in the Group. Any Wi-Fi Direct device is capable of being Group Master, and is able to negotiate with other Wi-Fi Direct devices as to which device will be the Group Master. A Group may include both Wi-Fi Direct devices and legacy devices (i.e., Wi-Fi certified devices that are not compliant with the Wi-Fi Alliance Peer-to-Peer Specification).

Wi-Fi Direct devices also support discovery, power management, managed device mechanisms, and concurrent infrastructure connections. Device discovery scans for and identifies other Wi-Fi Direct devices in order to establish a connection. Users can select a discovered device for connection, and if the discovered device is not already part of a Group, a new Group is formed. If the discovered device is already part of a Group, the scanning Wi-Fi Direct device may attempt to join the existing Group. Wi-Fi protected setup obtains credentials and authenticates the scanning Wi-Fi Direct device.

Service discovery enables the advertisement of services supported by higher layer applications (e.g., Bonjour, UPnP, and Web Service Discovery) to Wi-Fi Direct devices. Service discovery can be performed at any time (e.g. even before a connection is formed) with any other discovered Wi-Fi Direct device. For example, if a user wishes to print a photo, the printing application can identify which Wi-Fi Direct devices provide printing services and can present a compatible list of options to the user. As such, a camera can query to determine if Wi-Fi Direct devices are printers.

After a Group is formed, a Wi-Fi Direct device may invite another Wi-Fi Direct device to join the Group. The invited device may decline, accept, or ignore the invitation. Groups may be re-invoked for additional sessions after initial formation, and invitations can also be used to request that a previously used persistent Group be reformed. For example, a laptop could create a persistent Group comprised of the laptop and a printer. Persistent Groups may be restarted without provisioning, thus eliminating the need to repeat tasks such as entering a Wi-Fi Protected Setup PIN. Similarly, Wi-Fi Direct devices can store other persistent Group information and credentials.

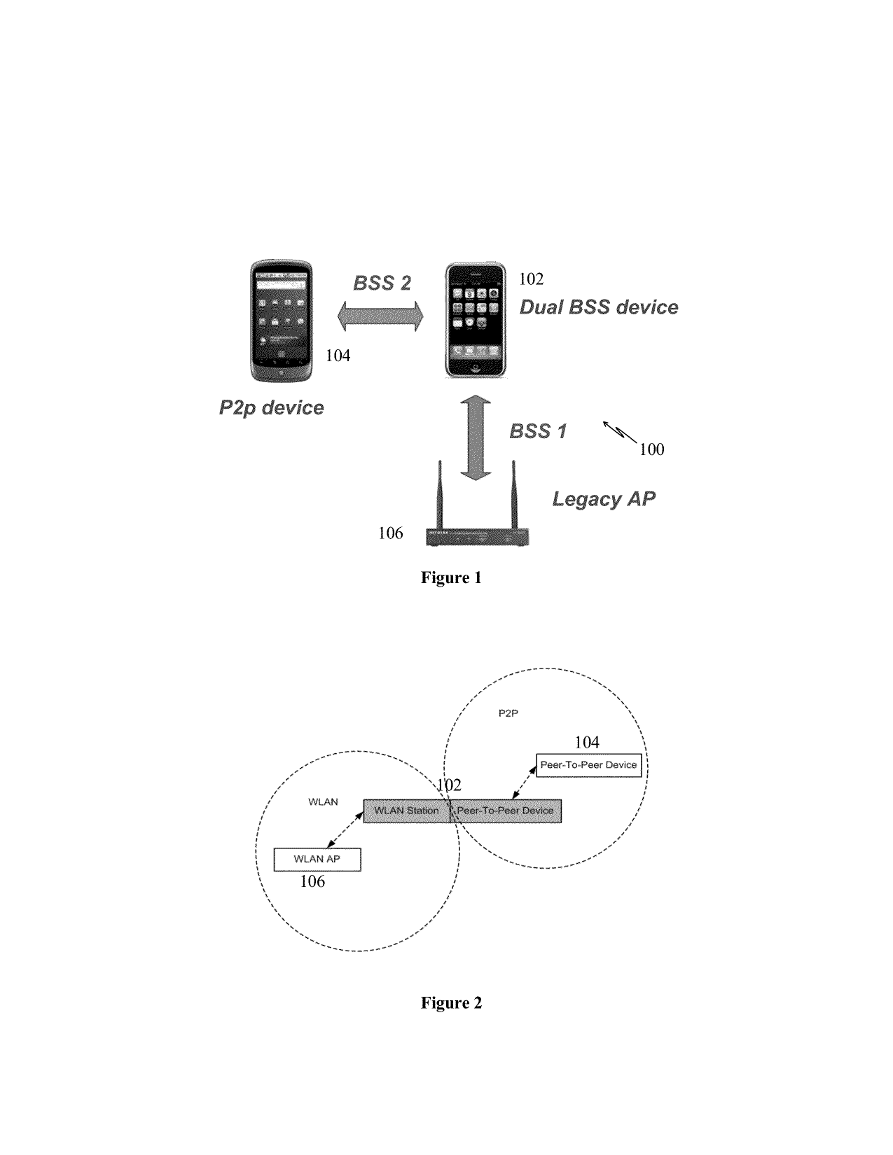

A Wi-Fi Direct Device that can be in a Group while maintaining a network infrastructure connection at the same time is a concurrent device or dual basic service set connection (“BSS”) device. A BSS is a set of stations and/or access points that have successfully synchronized using WLAN. Membership in a BSS does not imply that wireless communication with all other members of the BSS is possible. BSS may also refer to the channels, bands, etc. on which the devices communicate. For example, FIG. 1 illustrates a dual BSS device 102. The dual BSS device 102 has an established connection (BSS1) with a legacy AP 106 and another established connection (BSS2) with P2P device 104. As such, BSS2 supports a P2P connection and operates concurrently with BSS1. BSS1 is a TCP/FTP connection in at least one embodiment. The devices 102, 104, 106 and the BSSs make up the network 100. FIG. 2 illustrates that the network 100 can include two subnetworks. The P2P subnetwork includes P2P device 104, dual BSS device 102, and BSS2. The P2P subnetwork may be referred to as a second BSS network. The WLAN subnetwork includes legacy AP 106, dual BSS device 102, and BSS1. The WLAN subnetwork may be referred to as a first BSS network. Concurrent connections may be supported by a single transceiver in the dual BSS device 102, and may support connections on different channels.

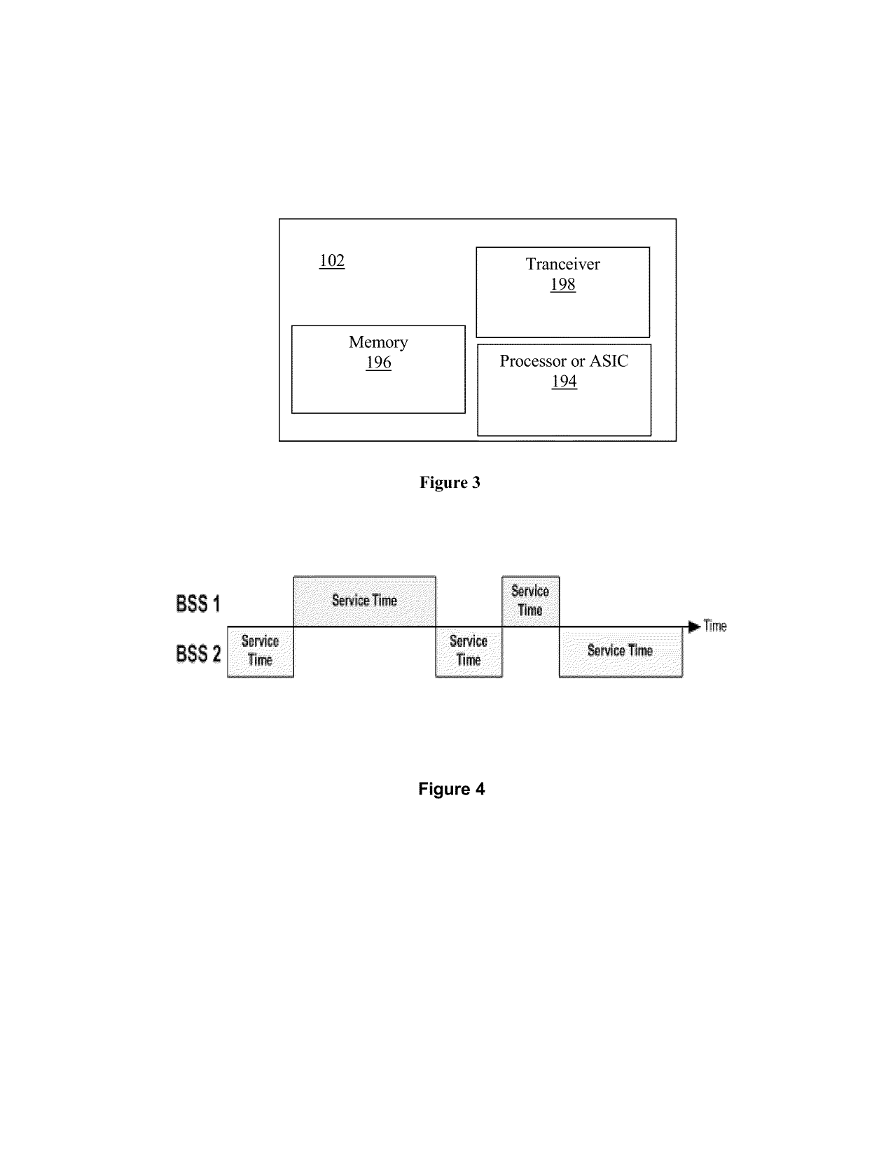

FIG. 3 illustrates the dual BSS device 102 in at least some embodiments. The device 102 includes non-transitory storage 196, a transceiver 198, and control logic 194. The control logic 194 comprises a processor or application specific integrated circuit (“ASIC”) in various embodiments. Any or all of the components may be coupled in at least some embodiments. The transceiver 198 may include an antenna and logic configured to process incoming and outgoing traffic. The storage 196 may include general or dedicated random access memory or non-volatile storage (e.g., read-only memory, flash storage, etc.). The control logic 194 can execute any action described herein. Specifically, instructions and software can be executed. The control logic 194 can control the transceiver 198 to communicate in the first BSS network and in the second BSS network. In some circumstances, the dual BSS device 102 may perform the role of group master or group owner in the second BSS network or another peer-to-peer network.

FIG. 4 illustrates service times in at least some embodiments. If the BSSs share the transceiver 198, then some dedicated time is allotted for each BSS to access the transceiver 198 to prevent both BSSs from accessing the wireless medium simultaneously. This dedicated time is referred to as the service time. A BSS within its assigned service time is an active BSS, while a BSS outside of its assigned service time is an inactive BSS. FIG. 4 illustrates that BSS1 and BSS2 alternate service times. However, it may be inefficient under some operating conditions for each service time to be the same length, especially if the service time is unneeded or not available when needed. The control logic 194 includes logic configured to adjust an original service time of a first BSS such as BSS1. The original service time is a service time that is predicted or scheduled to occur. If no service time is predicted or scheduled to occur, then adjusting the original service time means scheduling the current service time to accommodate predicted or scheduled packets on any BSS. Both BSS1 and BSS2 are associated with a communication device such as dual BSS device 102. At least one of the plurality of BSSs, such as BSS2, can support a peer-to-peer connection. Such peer-to-peer BSS networks may also be referred to as ad hoc BSS networks.

Adjusting service times may be referred to as adjusting dual BSS scheduling. The logic or processor 194 may dynamically adjust the dual BSS scheduling based on current communication loads associated with the transceiver 198 in each of the two BSS networks—the traffic load of the transceiver 198 in the first BSS network and the traffic load of the transceiver 198 in the second BSS network. The traffic load of the transceiver 198 in a BSS network comprises both current transmit traffic pending in a transmit queue of the device 102 and current pending receive traffic. The current pending receive traffic may be indicated, for example, by a transmit indication map (TIM) that is broadcast to the device 102 from the legacy AP 106. Broadcasting of the TIM may also be referred to as broadcasting a TIM advertisement. For example, if the transmit queue of the device 102 associated with the first BSS network is empty and if the TIM does not indicate pending downlink traffic, the processor 194 may command the transceiver 198 to transmit a sleep message to the first BSS network indicating that the device 102 is going to sleep. Additionally, the processor 194 may command the transceiver 198 to transmit an indication of when the device 102 will reawaken, for example an indication that the device 102 will reawaken in the first BSS network immediately prior to the next scheduled TIM transmission. The processor 194 may then cause the transceiver 198 to increase its service time in the second BSS network. If the dual BSS device 102 is a group owner in the second BSS network, if there is no communication load on the dual BSS device 102 from the second BSS network, the dual BSS device 102 may broadcast a notification of absence to the second BSS network.

In an embodiment, the processor 194 determines a balance of service time allocation to the first BSS network and to the second BSS network further based on a determination of traffic the device 102 has supported in each of the BSS networks in the past. For example, if the processor 194 determines that over the last hour, 25% of its communication has been in the first BSS network and 75% of its communication has been in the second BSS network, the processor 194 may adapt the dual BSS scheduling according to this average traffic load. This average traffic load may also be referred to as a windowed average, where the windowed average is determined over a period of time extending a predefined interval into the past up to the present, for example the most recent minute, the most recent 5 minutes, the most recent 15 minutes, the most recent hour, or some other time window.

The processor 194 may determine the service time allocation in part based on a current throughput that the transceiver 198 supports in each of the two BSS networks. Because the device 102 may move within the coverage of the two BSS networks, the signal strengths of radio links of the transceiver to the devices 104, 106 may change over time. As is known to those of skill in the art, the transceiver 198 may adapt its transmission throughput to promote robust communication under different radio conditions, for example by using a modulation scheme having a smaller quadrature amplitude modulation (QAM) constellation or for example by modulating using more redundancy in the encoding scheme. For example, if transceiver 198 receives weak signals from the legacy AP 106, the throughput rate of the communications with the legacy AP 106 may be reduced. If the transceiver 198 receives strong signals from the device 104 in the peer-to-peer network, for example because the device 102 may be close to the device 104, the throughput rate of the communications with the device 104 may be increased. Thus, if the windowed average traffic load in bytes is equal in both BSS networks but the throughput of the device 102 to the device 104 is twice that of the throughput of the device 102 to the legacy AP 106, the processor 194 may allocate ⅓ of the service time to the second BSS network and ⅔ of the service time to the first BSS network. Thus, when there is a communication load on the device 102 in both BSS networks, it is contemplated that the processor 194 adapts the dual BSS scheduling both based on a windowed average of the traffic load of the device 102 in each BSS network and based on a current throughput supported by the transceiver 198 in each BSS network.

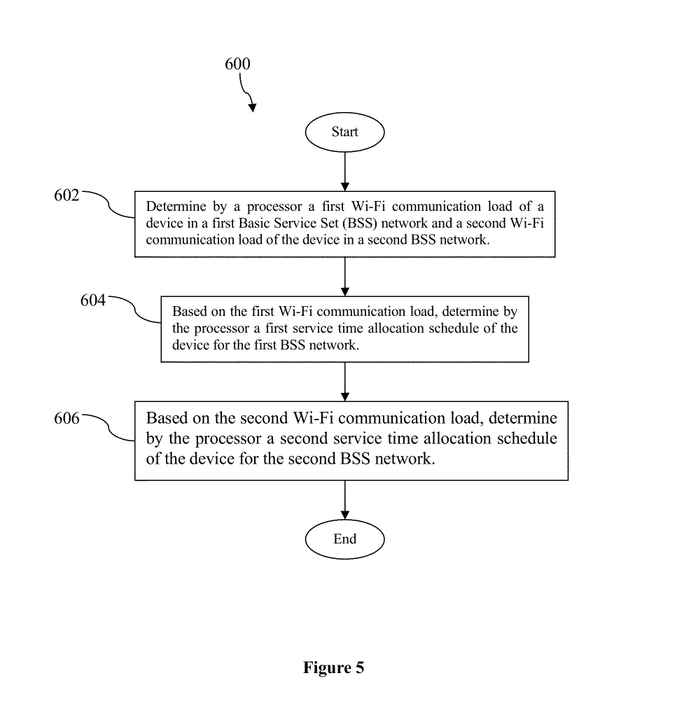

FIG. 5 is a flow chart of a method 600 according to an embodiment of the disclosure. It is understood that some of the processing of the method 600 may be performed in different sequences and/or concurrently. At block 602, a processor determine a first Wi-Fi communication load of a device in a first Basic Service Set (BSS) network and a second Wi-Fi communication load of the device in a second BSS network. For example, the control logic 194 determines the communication loads of the dual BSS device 102 in each of the first and second BSS networks. The communication load may be determined in bytes or in some other unit of communication volume. At block 604, the processor determines a first service time allocation schedule of the dual BSS device 102 for the first BSS network based at least in part on the first Wi-Fi communication load determined in block 602 above. The transceiver 198 may transmit an indication of the service time allocation schedule to the first BSS network, for example to the legacy AP. If the processor 194 determines that the dual BSS device 102 needs no service time in first BSS network, the transceiver 198 may broadcast a sleep message and/or a message defining when the device 102 will reawaken. At block 606, the processor determines a second service time allocation schedule of the dual BSS device 102 based at least in part on the second Wi-Fi communication load determined in block 602 above. The transceiver 198 may transmit an indication of the service time allocation schedule to the second BSS network, for example to one or more peers in the second BSS network. If the processor 194 determines that the dual BSS device 102 needs no service time in second BSS network, the transceiver 198 may broadcast a sleep message and/or a message defining when the device 102 will reawaken. As discussed further above, the determination of service time in one of the BSS networks may be based in part on the determination of service time in the other of the BSS networks. For example, the service time allocations determined in blocks 604, 606 may be determined so as to balance the communication loads of the two BSS networks relative to the dual BSS device 102. In this way, the service time allocation of the dual BSS device 102 in the two BSS networks are balanced and optimized.

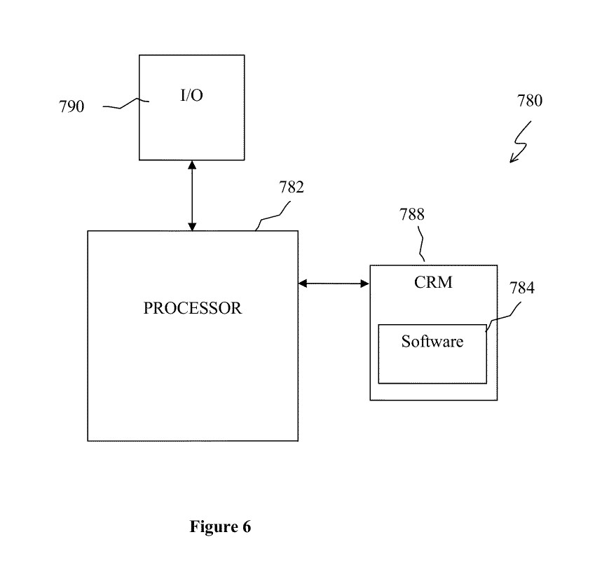

The system described above may be implemented on any particular machine or computer with sufficient processing power, memory resources, and throughput capability to handle the necessary workload placed upon the computer. FIG. 6 illustrates a particular computer system 780 suitable for implementing one or more embodiments disclosed herein. The computer system 780 includes a processor 782 (which may be referred to as a central processor unit or CPU) that is in communication with memory devices including storage 788, and input/output (I/O) 790 devices. The processor may be implemented as one or more CPU chips or an ASIC. In various embodiments, the storage 788 comprises a computer-readable medium such as volatile memory (e.g., RAM), non-volatile storage (e.g., Flash memory, hard disk drive, CD ROM, etc.), or combinations thereof. The storage 788 comprises software 784 or firmware that is executed by the processor 782. One or more of the actions described herein are performed by the processor 782 during execution of the software 784 or firmware.

Embodiments of the present invention may be implemented in the form of software, firmware, hardware, application logic, or a combination of software, firmware, hardware, and application logic. The software, firmware, application logic and/or hardware may reside on integrated circuit chips, modules, or memories. If desired, part of the software, firmware, hardware and/or application logic may reside on integrated circuit chips, part of the software, firmware, hardware and/or application logic may reside on modules, and part of the software, firmware, hardware and/or application logic may reside on memories. In one exemplary embodiment, the application logic, software, firmware, or an instruction set is maintained on any one of various conventional non-transitory machine-readable media.

Processes and logic flows which are described in this specification can be performed by one or more programmable processors executing one or more computer programs to perform functions by operating on input data and generating output. Processes and logic flows can also be performed by special purpose logic circuitry, e.g., an FPGA (field programmable gate array) or an ASIC (application-specific integrated circuit). Apparatus or devices which are described in this specification can be implemented by a programmable processor, a computer, a system on a chip, or combinations of them, by operating on input date and generating output. Apparatus or devices can include special purpose logic circuitry, e.g., an FPGA or an ASIC. Apparatus or devices can also include, in addition to hardware, code that creates an execution environment for computer program, e.g., code that constitutes processor firmware, a protocol stack, a database management system, an operating system, a cross-platform runtime environment, e.g., a virtual machine, or a combination of one or more of them.

Generally, a processor will receive instructions and data from a read-only memory or a random access memory or both. The elements of a computer generally include a processor for performing or executing instructions, and one or more memory devices for storing instructions and data. Machine-readable media may include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. A computer program (also known as, e.g., a program, software, software application, script, or code) can be written in any programming language, including compiled or interpreted languages, declarative or procedural languages, and it can be deployed in any form, including as a stand-alone program or as a module, component, subroutine, object, or other unit suitable for use in a computing environment. A computer program can be deployed to be executed on one computer or on multiple computers that are located at one single site or distributed across multiple sites and interconnected by a communication network.

Certain features that are described in the context of separate embodiments can also be combined and implemented as a single embodiment. Conversely, various features that are described in the context of a single embodiment can also be implemented in multiple embodiments separately or in any suitable subcombinations. Moreover, although features may be described as acting in certain combinations and even initially claimed as such, one or more features from a combination as described or a claimed combination can in certain cases be excluded from the combination, and the claimed combination may be directed to a subcombination or variation of a subcombination. Although various aspects of the invention are set out in the independent claims, other aspects of the invention comprise other combinations of features from the embodiments and/or from the dependent claims with the features of the independent claims, and not solely the combinations explicitly set out in the claims. Certain functions that are described in this specification may be performed in a different order and/or concurrently with each other. Furthermore, if desired, one or more of the above-described functions may be optional or may be combined.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications. Additionally, audio or visual alerts may be triggered upon successful completion of any action described herein, upon unsuccessful actions described herein, and upon errors.

What is claimed is:

1. An integrated circuit, comprising:
logic configured to determine a communication schedule of a device configured to perform Wi-Fi communications in a first Basic Service Set (BSS) network and in a second BSS network, wherein the logic determines the communication schedule based at least in part on a first BSS network communication load of the device and on a second BSS network communication load of the device, and wherein the communication schedule defines the service time allocation of the device in the first BSS network and the service time allocation of the device in the second BSS network;
wherein at least one of the first and the second BSS networks is supportive of a peer-to-peer connection.

2. The integrated circuit of claim 1, wherein the logic is configured to determine the first BSS network communication load of the device based on a transmit indication map (TIM) advertisement received by the device.

3. The integrated circuit of claim 2, wherein the logic is configured to determine the first BSS network communication load of the device further based on a content of a transmit buffer of the device.

4. The integrated circuit of claim 3, wherein the logic is configured to transmit an indication that the device is going to sleep when the TIM advertisement and the transmit buffer of the device indicates there is no current first BSS network communication load of the device,

5. The integrated circuit of claim 1, wherein the logic is configured to allocate service time of the device to the first BSS network and to the second BSS network based on a recent first BSS network communication load of the device and on a recent second BSS network communication load of the device,

6. The integrated circuit of claim 5, wherein the logic is configured to allocate service time of the device further based on a first rate of communication of the device in the first BSS network and based on a second rate of communication of the device in the second BSS network.

7. The integrated circuit of claim 1, wherein the logic is configured to transmit a notice of absence in the second BSS network when there is no current second BSS network communication load.

8. The integrated circuit of claim 7, wherein the logic is configured to act as a group master in the second BSS network.

9. A method comprising:
determining by a processor a first Wi-Fi communication load of a device in a first Basic Service Set (BSS) network and a second Wi-Fi communication load of the device in a second BSS network;
based on the first Wi-Fi communication load, determining by the processor a first service time allocation schedule of the device for the first BSS network; and
based on the second Wi-Fi communication load, determining by the processor a second service time allocation schedule of the device for the second BSS network.

10. The method of claim 9, wherein the processor determines the first Wi-Fi communication load of the device based at least in part on a transmit indication map (TIM) broadcast in the first BSS network.

11. The method of claim 10, wherein the processor determines the first Wi-Fi communication load of the device based at least in part on a first transmit queue of the device, where the first transmit queue contains communication to be transmitted by the device to the first BSS network.

12. The method of claim 9, wherein the processor determines the first and second service time allocations based on balancing the first and second Wi-Fi communication loads of the device.

13. The method of claim 12, wherein the processor balances the first and second Wi-Fi communication loads of the device based on a communication rate of the device in each of the first and second BSS networks and based on a recent average of communication traffic of the device in the first and second BSS networks.

14. The method of claim 9, wherein the first BSS network is a legacy Wi-Fi network.

15. The method of claim 9, wherein the second BSS network is an ad-hoc Wi-Fi network.

16. The method of claim 15, wherein the device is a group master in the second BSS network.

17. An integrated circuit, comprising:
logic configured to determine a communication schedule of a device configured to perform Wi-Fi communications in a first Basic Service Set (BSS) network and in a second BSS network, wherein the logic determines the communication schedule based at least in part on a first BSS network communication load of the device and on a second BSS network communication load of the device, and wherein the communication schedule defines the service time allocation of the device in the first BSS network and the service time allocation of the device in the second BSS network;
wherein the first BSS network is a legacy Wi-Fi network and the second BSS network supports a peer-to-peer connection;
wherein determining the first BSS network communication load comprises identifying a downlink traffic pending by reading a transmit indication map (TIM) and determining uplink traffic pending on the device.

18. The integrated circuit of claim 17, wherein if the logic determines the second BSS network has no pending traffic load for the device, the logic causes the device to transmit a notice of absence to the second BSS network.

19. The integrated circuit of claim 18, wherein the device acts as a group owner of the second BSS network.

20. The integrated circuit of claim 17, wherein if the logic determines that the first BSS network has pending traffic load for the device, the logic causes the device to transmit a sleep message to the first BSS network.
